(19) United States
(12) Patent Application Publication
(10) Pub. No.: US 2018/0099880 A1
(43) Pub. Date: Apr. 12, 2018

(54) METHOD FOR REMOVING CYANOTOXIN FROM WATER USING A PLASMA DEVICE

(71) Applicant: THE REGENTS OF THE UNIVERSITY OF MICHIGAN, Ann Arbor, MI (US)

(72) Inventors: Janis C. LAI, Ann Arbor, MI (US); John E. FOSTER, Ann Arbor, MI (US)

(21) Appl. No.: 15/727,255

(22) Filed: Oct. 6, 2017

Related U.S. Application Data
(60) Provisional application No. 62/405,591, filed on Oct. 7, 2016.

(51) Int. Cl. C02F 1/46; C02F 1/78; C02F 1/72; C02F 1/00

(52) U.S. Cl. CPC C02F 1/4608; C02F 1/78; C02F 2101/38; C02F 1/001; C02F 1/722

(57) ABSTRACT

A method for treating water is provided. The method includes feeding gas through a dielectric barrier discharge (DBD) jet device having an electrode and a ground electrode disposed in water comprising at least one organic toxin derived from a biological organism to generate a cavity in the water, and powering the electrode such that a plasma jet is generated in the cavity. The plasma jet interacts with the water to generate oxidizing agents that oxidize and decompose organic toxins in the water.

### CROSS-REFERENCE TO RELATED APPLICATIONS

This application claims the benefit of U.S. Provisional Application No. 62/405,591, filed on Oct. 7, 2016. The entire disclosure of the above application is incorporated herein by reference.

### GOVERNMENT SUPPORT

The invention was made with government support under DE-SC0001939 awarded by the U.S. Department of Energy. The Government has certain rights in the invention.

### FIELD

The present disclosure relates to methods for detoxifying water containing cyanobacteria-derived algal blooms and their associated toxins.

### BACKGROUND

This section provides background information related to the present disclosure which is not necessarily prior art.

Cyanobacteria (blue green algae)-derived algal blooms have risen in public attention in recent years owing to its harmful effects on humans and animals. These blooms occur under favorable conditions of temperature (typically summer), light and where there is an abundance of nutrients such as nitrates and phosphorous. The abundance of nutrients is often anthropogenic in nature, typically associated with agriculture runoff into source water bodies. Under conditions that are still not well-understood, the cyanobacteria release toxins into the water naturally. The release of toxins can also occur when algal cells are damaged. While, the cyanobacteria produce a range of toxins, the toxin of chief concern is hepatotoxin microcystin-LR, where the “L” and the “R” represent the variable amino acid groups leucine and arginine, respectively. Microcystin-LR is generally referred to as “microcystin” herein. This large molecule (MW 995.2) is a hepatotoxin that can cause human and non-human animal diseases ranging from liver damage to tumor promotion. Indeed, the introduction of this toxin into source water during an algal bloom in Brazil in 1996 is believed to be the source of 51 deaths of patients at a dialysis facility. Moreover, the National Cancer Institute nominated blue-green algae supplements for study by the National Toxicology program because of concerns regarding the potential carcinogenicity of microcystin-LR. Ordinarily, this toxin biodegrades over time. For example, some studies suggest that the degradation occurs naturally over a period of days to up to a week. However if left in the dark (sediments of water source), microcystin can persist for years. Also problematic is the bioaccumulation of the microcystin toxin in fish and shell fish. The cyanobacterial proliferation under algal bloom conditions also affects overall water appearance and can lead to dead zones in source water owing to reduction in oxygen concentration in water associated with decaying algae.

The presence of microcystin in source drinking water is problematic for conventional water treatment methods. Indeed, the persistence of algal blooms in the water in the Lake Erie Region and in the State of Ohio has even led to drinking water advisories and in cases an outright drinking water ban. The World Health Organization, shortly after the microcystin-derived illnesses and deaths in Brazil, put forth a maximum concentration limit for microcystin of 1 μg/L. Currently, the U.S. Environmental Protection Agency (EPA) has not established a maximum concentration level for microcystin. In this regard, the substance is unregulated. The U.S. EPA has; however, placed microcystin on its Contaminant Candidate List. On the other hand, states can set self-imposed threshold standards for action. For example, the State of Ohio has established a no drinking and no contact recreation threshold of 20 μg/L for microcystin.

Conventional water treatment methods involve coagulation, flocculation, and filtering followed typically by chlorination. Mechanical processing of fragile cyanobacteria can lead to cell membrane damage, i.e., lysis, leading to the release of the toxins, which compounds the removal problem. While chlorination can be an effective means of decomposing microcystin, microcystin-derived disinfection byproducts that form in the process are themselves a toxicity problem. In general, granular activated charcoal/carbon (GAC) has shown great promise in the removal of microcystin. However, the use of GAC requires careful management and backwashing to flush out accumulated contaminants. Additionally, it has been shown that GAC loses effectiveness in the presence of chlorine and heavy natural organic matter concentrations, which compete for absorption sites. It has also been shown that bioremediation may also be effective in the removal of microcystin. One attractive attribute borne out of bioremediation studies is the absence of cytotoxic byproducts after treatment. On the other hand, long treatment times required by bioremediation may preclude this approach from practical implementation. Interestingly, it has been shown that GAC microcystin-LR removal may actually be assisted by the presence of a bioremediating layer on the carbon particle surface.

In recent times, there has been a great deal of interest in advanced oxidation methods as a means to remove organic toxins in water via a process known as mineralization. With mineralization, the toxins are reduced to carbon dioxide, water and inorganic salts via multiple reactions with OH radicals produced in solution. Advanced oxidation can be used not only against those recalcitrant organics beyond the range of conventional or bioremediation methods, but further generally does not appear to produce toxic intermediates. Advanced oxidation has been investigated as a means of addressing the microcystin toxin. Decomposition mechanisms via OH radicals have been studied using pulsed radiolysis. There, it was found that addition to the microcystin benzene ring and abstraction of aliphatic hydrogen are two key mechanisms that destroy the biological activity of the substance. Ozone, another advanced oxidation species, has shown great effectiveness at decomposing microcystin. Disinfection byproducts, however, are a concern for ozone-based methods. The use of UV with titanium oxide has also shown great promise microcystin degradation without the production of disinfection byproducts. Scale-up of this method however has not been demonstrated in regards to actual implementation in a pilot plant. Accordingly, methods for removing toxins in water without the foregoing drawbacks are desirable.

### SUMMARY

This section provides a general summary of the disclosure, and is not a comprehensive disclosure of its full scope or all of its features.

The current technology provides a method for treating water. The method includes inserting an electrode and ground electrode of a dielectric barrier discharge (DBD) plasma jet device into water to be treated, feeding gas through the DBD jet device to generate a cavity in the water, and powering the electrode such that a plasma jet is generated in the cavity. The water to be treated may comprise at least one organic toxin. The plasma jet interacts with the water to generate oxidizing agents that oxidize and decompose the at least one organic toxin in the water.

The current technology also provides a method for treating water containing a cyanotoxin, such as microcystin-LR. The method includes inserting an electrode and ground electrode of a dielectric barrier discharge (DBD) plasma jet device into water to be treated, feeding air through the DBD plasma jet device to generate a cavity in the water, and powering the electrode such that a plasma jet is generated in the cavity. The plasma jet interacts with the water to generate an oxidizing agent that oxidizes and decomposes the cyanotoxin in the water. The oxidizing agent includes hydroxyl radicals, hydrogen peroxide, ozone, or any combination thereof.

Additionally, the current technology further provides another method for treating water comprising microcystin-LR. The method includes inserting an electrode and ground electrode of a dielectric barrier discharge (DBD) plasma jet device into the water. The DBD plasma jet device includes a housing that defines a hollow interior core that extends from a first opening at a first end of the housing to a second opening at a second end of the housing; a port having a third opening, the port being disposed at a first region of the housing near the first end of the housing, wherein the third opening is in fluid communication with the hollow interior core by way of a bore; the electrode is disposed through the third opening and within the hollow interior core of the housing and extends through the hollow interior core to a second region near the second end of the housing; and the ground electrode disposed on the housing at the second region. The method also includes feeding gas through the first opening of the DBD plasma jet device to generate a cavity in the water below the second opening, and powering the electrode such that a plasma jet is generated in the cavity. The plasma jet interacts with the water to generate oxidizing agents that oxidize and decompose the microcystin-LR in the water.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is an illustration of a dielectric barrier discharge (DBD) plasma jet device according to various aspects of the current technology;

FIG. 1B is an illustration of a circuit that corresponds to the DBD plasma jet device of FIG. 1A;

FIG. 2 is a flow chart describing a method for treating water according to various aspects of the current technology;

FIG. 3 is a chemical structure of microcystin-LR;

FIG. 4 is a graph showing concentrations of remaining microcystin-LR in samples treated with plasma for various times;

FIG. 5 shows a mass spectrum of an untreated microcystin-LR sample at an acquisition time of from 7.320-7.535 minutes; and

FIG. 6 shows a mass spectrum is a microcystin-LR sample treated for 10 seconds according to various aspects of the current technology, at an acquisition time of from 7.385-7.534 minutes.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Non-equilibrium, atmospheric pressure plasmas can be used for degradation of organics in solution. Plasmas in contact with water produce OH radicals directly via mechanisms such as dissociative attachment, direct bombardment, or the production and subsequent decomposition of hydrogen peroxide. OH radical itself is highly reactive particularly with organic compounds (such as contaminants) and thus has a very short lifetime. The presence of peroxide and ozone serve as additional sources in the production the OH radical. Equations prevailing in the OH production cycle may be summarized as:

e⁻+H₂O→OH^{⋅}+H^{⋅}+e⁻,

OH^{⋅}+OH^{⋅}→H₂O₂,

H₂O₂+UV→2OH^{⋅},

H₂O₂+e⁻_{(aq)}→OH⁻+OH^{⋅},

OH^{⋅}+H₂O₂→H₂O+HO₂^{⋅}, and

HO₂^{⋅}+H₂O₂→O₂+H₂O+OH^{⋅};

and via ozone produced in the plasma:

O₃+UV→O₂+exited O(¹D), and

O(¹D)+H₂O→2OH^{⋅}.

Plasma production in water can also produce ozone as well as air used as the working gas. These plasmas introduce UV light into solution as well. In accordance with certain aspects of the present technology, these advanced oxidation mechanisms, which all occur simultaneously, can be brought to bear on the decomposition of organic toxins, including microcystin as a non-limiting example, in solution.

The present technology pertains to the utilization of a nanosecond pulse driven underwater plasma jet with an oxygen-containing or oxidant-containing gas, such as air, as the feed gas to generate oxidizing agents for decomposing organic toxins. As used herein, “organic toxins” are organic toxins that are subject to degradation by oxidation. Non-limiting examples of organic toxins include cyanotoxins, N-nitrosodimethylamine (NDMA), methyl tert-butyl ether (MTBE), and organic dyes, wherein microcystin is a non-limiting example of a cyanotoxin. Accordingly, organic toxins may be derived and/or released from biological organisms, such as cyanobacteria. With the plasma jet, plasma generated reactants are directly injected into solution without diffusion losses or sensitivity to liquid surface layer conditions. Additionally, electrolytic processes and particle formation at an electrode, as would occur in glow discharge configurations, are avoided. A time-resolved degradation of toxins may be tracked using an enzyme-linked immunosorbent assay (ELISA) test kit and high-pressure liquid chromatography-mass spectrometry. To access the chemistry behind the observed degradation, the production rate of hydrogen peroxide, a key advanced oxidation agent, may be tracked as a function of time using a hydrogen peroxide test kit, such as hydrogen peroxide test kit, model HYP-1, commercialized by Hach (Loveland, Colo.). Decomposition products may also be tracked as a function of time using high-pressure liquid chromatography-mass spectrometry (HPLC-MS).

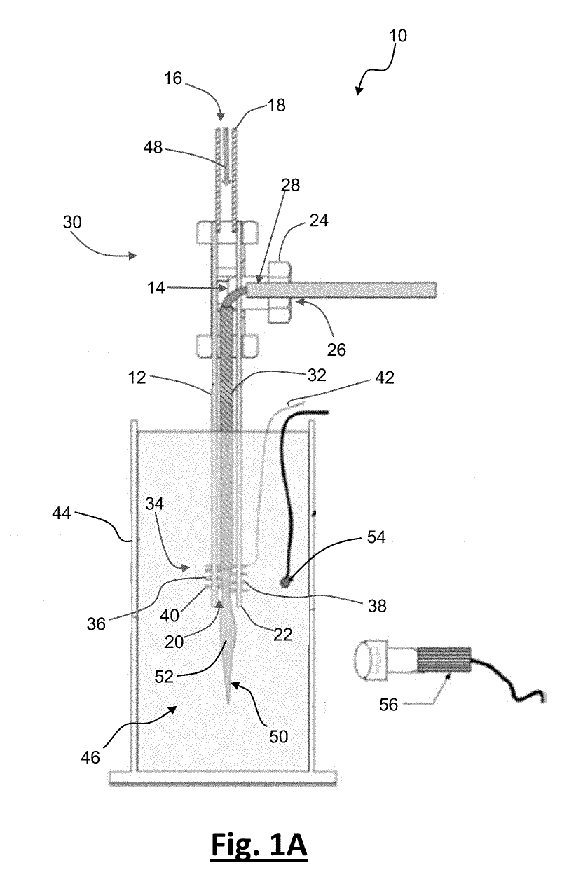

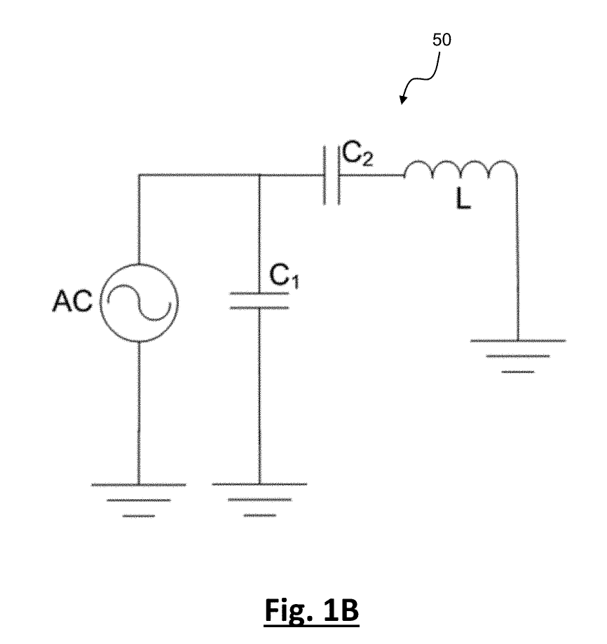

FIG. 1A is a cross-sectional illustration of a gas-driven dielectric barrier discharge (DBD) plasma jet device 10 that is used to affect the chemical reactivity of liquid water. Unlike conventional atmospheric pressure plasma jets, the active portion of the DBD plasma jet device 10 operates submerged in liquid water (e.g., underwater), providing in-volume treatment. The DBD plasma jet device 10 comprises a housing 12 having a hollow interior core 14 that extends from a first opening 16 at a first end 18 of the housing 12 to a second opening 20 at a second end 22 of the housing 12. The shape of the housing 12 is not limiting, such that the housing 12 may have a cross-sectional geometry that is circular, oval, square, triangular, hexagonal, etc. In FIG. 1A, the housing 12 is depicted as having a circular cross-sectional geometry, such that the housing 12 is an elongate tube or cylinder. The housing 12 is composed of a dielectric or ceramic material. The ceramic material may be an oxide, carbide, nitride, phosphate, or carbonate of metal or metalloid. Non-limiting examples of ceramic oxides include Al₂O₃ (alumina), SiO₂ (silica), B₂O₃, CaO, K₂O, Na₂O, MgO, Fe₂O₃, FeO, Fe₃O₄, ZnO, TiO₂, ZrO₂, BaO, Li₂O, PbO, SrO, and combinations thereof, non-limiting examples of ceramic carbides include SiC, CaC₂, Mo₂C, B₄C, Al₄C₃, WC, ZrC, VC, TiC, and combinations thereof, non-limiting examples of ceramic nitrides include AlN, BN, Ba₃N₂, Si₃N₄, Ti₂CN, Ca₃N2, GaN, Ge₃N₄, InN, Li₃N, Mg₃N₂, Sr₃N₂, TiN, ZrN, and combinations thereof, non-limiting examples of ceramic phosphates include Ca₂P₂O₇.xH₂O, Ca₃(PO₄)₂, KH₂PO₄, NaH₂PO₄, ZrP, Fe(H₂PO₄)₂, FeH(HPO₄)₂, FePO₄, and combinations thereof, and non-limiting examples of ceramic carbonates include BaCO₃, CoCO₃, CaCO₃, CuCO₃, Li₂CO₃, Na₂CO₃, MgCO₃, SrCO₃, NiCO₃, K₂CO₃, and combinations thereof.

The housing 12 includes a port 24. The port 24 includes a third opening 26 that is in fluid communication with the hollow interior core 14 by way of an internal bore 28. As shown in FIG. 1A, the port 24 is disposed orthogonal to the housing 14 at a region 30 near the first end 18. An electrode 32 having been fed through the third opening 26 of the port 24 is disposed within the hollow interior core 14 of the housing 12 and extends through the hollow interior core 14 to a second region 34 near the second end 22 of the housing 12. The electrode 32 may be composed of any electrically conductive material used in the art, such as copper, silver, gold, platinum, stainless steel, or tinned copper as non-limiting examples. The geometry of the electrode 32 is not limiting and may be, for example, cylindrical.

The DBD plasma jet device 10 also comprises a ground electrode 36 disposed on the housing 12 near the second region 34. In certain aspects of the current technology, the ground electrode 36 is a coil of wire 38 wrapped about the second region 34 of the housing 12. The ground electrode 36 can be composed of any material known in the art, such as, tantalum, stainless steel, and copper as non-limiting examples. The ground electrode 36 can be insulated from a liquid environment by a coating of insulation 40. The coating of insulation can be composed of any material known in the art, such as by polyimide. KAPTON® polyimide film commercialized by DuPont (Wilmington, Del.) is a non-limiting example of a suitable polyimide. The ground electrode 36 is grounded to an external ground by a ground wire 42.

The DBD plasma jet device 10 is operated by submerging at least the second region 34 of the housing 12 into a container 44 containing water 46 and feeding gas 48 into the first opening 16 at the first end 18 of the housing 12. The gas can be any gas known in the art. In certain aspects of the current technology, the gas is air. For example, feeding gas into the first opening 16 can include feeding air into the first opening 16 using an air compressor. Air flow can be measured using an inline airflowrotameter. In various embodiments, the airflow is greater than or equal to about 0.5 L/min to less than or equal to about 100 L/min. However, it is understood that the airflow is dependent on the size of the DBD plasma jet device and the volume of water to be treated. Therefore, the airflow may be scaled up or down as necessary. The gas 48 is injected into the water 46 by way of the second opening 20 at the second end 22 of the housing 12, which leads to bubble break-off, which leads to the formation of a plurality of smaller bubbles. The method of gas injection does not lead to true bubbling; rather, it may be characterized as water agitation by direct injection of the 48 gas. The forced gas 48 forms an unstable cavity or pocket 50 in the water 46. The cavity 50 is inherently unstable, giving rise to breaking and subsequent bubble formation.

The operation of the DBD plasma jet device 10 also includes powering the electrode 32 with a variable frequency AC source through a high voltage pulsed power modulator/transformer capable of providing positive voltage pulses of up to about 30 kV at a repetition rate of less than or equal to about 20 kHz, such as a repetition rate of greater than or equal to about 1 kHz to less than or equal to about 20 kHz. Powering the electrode 32 generates a plasma jet 52 in the cavity 50. In various embodiments, a thermocouple 54 is submerged in the water 46 to monitor plasma-induced water temperature changes as a function of time. Also, current can be measured with a current monitor or coil, voltage can be measured with a voltage probe, and a spectrometer 56 can be used to assess species content in the plasma jet 52. The plasma jet 52 reacts with the water 46 to generate oxidizing agents, such as reactive hydroxyl radicals, hydrogen peroxide, and ozone.

FIG. 1B is a drawing of a circuit that corresponds to the DBD plasma jet device 10 of FIG. 1A. Here, AC represents an alternating current (AC) power source and C₁ represents the effective capacitance of the electrode 32 to ground through an intervening material, i.e., the ceramic housing 12, the air cavity 50 produced just below the second opening 20 or exit plane of the housing 12 during operation, and the water 46. C₂ represents the capacitance between the electrode 32 and ground electrode 36. Gas 48, i.e., air, is fed into the housing 12, for example with the use of a compact air compressor.

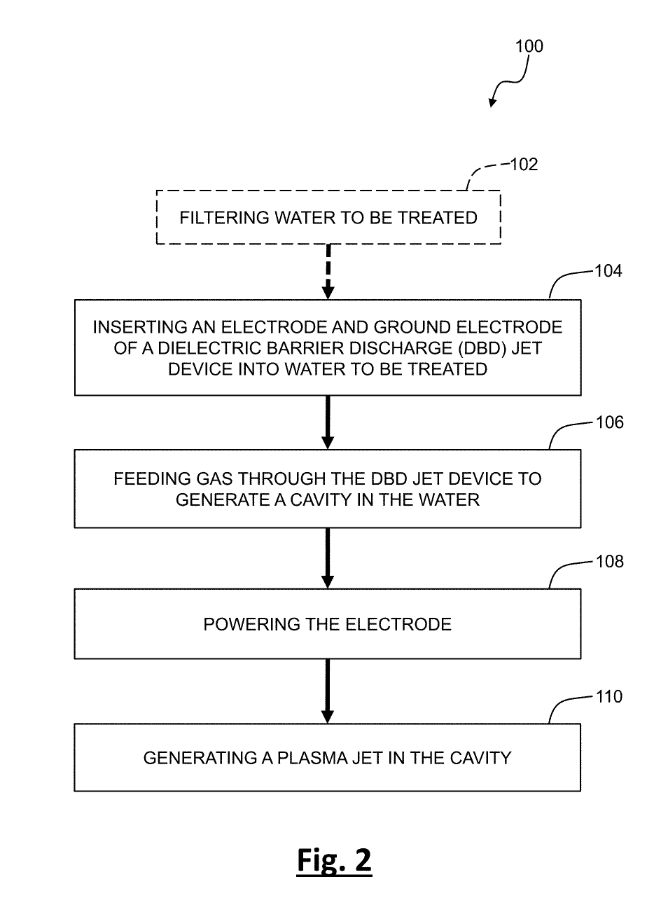

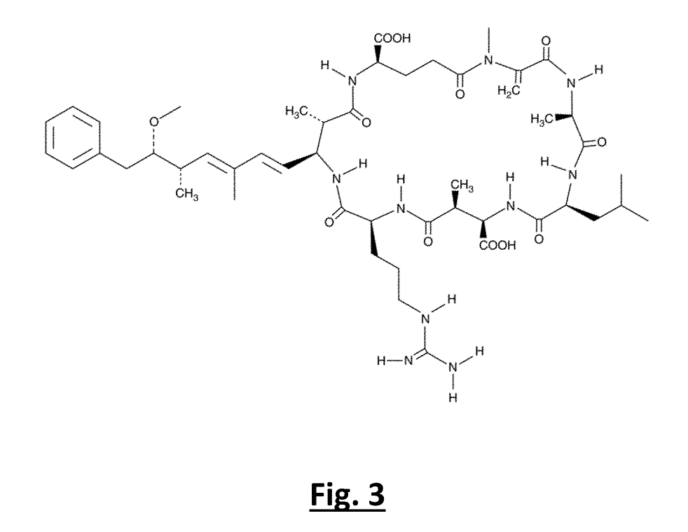

With reference to FIG. 2, the current technology also provides a method 100 for treating water. In particular, the method 100 can be performed to treat water containing or suspected of containing at least one organic toxin. An exemplary organic toxin is microcystin. FIG. 3 shows the chemical structure of microcystin, which includes a seven-member peptide ring. As described above, microcystin is generated and released by cyanobacteria (blue green algae)-derived algal blooms and is associated with pathological conditions in animals, including humans, ranging from liver damage to tumor promotion. Conventional methods for treating water containing microcystin generate microcystin byproducts, which themselves are cytotoxic. The current method 100 obviates this drawback by oxidizing microcystin, which decomposes the toxin and renders the toxin harmless. No toxic byproducts are generated by the method 100.

Referring back to FIG. 2, in block 102 the method 100 optionally includes filtering water to be treated. The water may contain, for example, algal bloom cells that may be removed from the water by filtration. However, filtration may also cause cell damage and/or cell lysis, which exposes the interior content of the cells, including organic toxins, to the water. Therefore, filtering may introduce organic toxins to the water in addition to the organic toxins that may already be present in the water. Filtering may be performed, for example, by passing the water through a bed of sand and gravel, whereby suspended particles and cells are trapped in the bed of sand and gravel.

Other optional pretreatment steps may be performed as well, prior to filtering, such as prechlorination, coagulation/flocculation, and sedimentation. Prechlorination includes adding chlorine to the water to kill microorganisms, such as bacteria, protozoa, and viruses and to kill and/or prevent the growth of algae. Coagulation includes adding aluminum sulfate to the water to cause particles and colloids suspended in the water to clump together to form heavier particles. Mixing these heavier particles causes flocculation, i.e., the generation of floc. After flocculation, the water and floc may move slowly through settling basins for sedimentation, whereby the floc settles to the bottom of the basin as the water moves by. Fluoridation, i.e., adding fluorine to the water, may also be performed. However, fluoridation may be performed any time during the treatment process, such as before or after filtration.

In block 104, the method 100 includes inserting an electrode and ground electrode of a DBD jet device into the water to be treated. In certain aspects of the current technology, the DBD jet device is the DBD jet device described above with reference to FIGS. 1A and 1B. Then, in block 106 the method 100 includes feeding gas through the DBD jet device to generate a cavity in the water. The gas is fed through a first opening at a first end of the DBD jet device and the cavity is generated in the water below a second opening at a second end of the DBD jet device. Accordingly, in some embodiments, the method 100 comprises feeding gas through a dielectric barrier discharge (DBD) jet device having an electrode and a ground electrode disposed in water comprising at least one organic toxin derived from a biological organism to generate a cavity in the water.

In block 108, the method 100 includes powering the electrode and in block 110 the method 100 includes generating a plasma jet in the cavity. Powering the electrode may occur with a variable frequency AC source as described above. The variable frequency AC source provides positive voltage pulses of from greater than or equal to about 1 kV to less than or equal to about 30 kV at a repetition rate of from greater than or equal to about 1 kHz to less than or equal to about 20 kHz. The plasma jet interacts with the water to generate oxidizing agents selected from the group consisting of hydroxyl radicals, hydrogen peroxide, ozone, and combinations thereof that oxidize and decompose organic toxins in the water, such as microcystin as a non-limiting example.

Greater than or equal to about 75% by mass of organic toxins, for cyanotoxins or cyanotoxin byproducts, initially present can be removed from a 20 mL sample of water containing organic toxins in greater than or equal to about 1 minute to less than or equal to about 24 hours by following the method 100. In various embodiments, the percent removal of organic toxins is from greater than or equal to about 75% to less than or equal to 100% (where 100% reduction refers to a level of organic toxin below a detection limit), from greater than or equal to about 80% to less than or equal to about 99%, or from greater than or equal to about 90% to less than or equal to about 95% in from greater than or equal to about 1 minute to less than or equal to about 24 hours. In certain aspects of the current technology, from greater than or equal to about 95% to less than or equal to about 99% of organic toxins can be removed from water in from greater than or equal to about 1 minute to less than or equal to about 10 minutes of plasma jet treatment. The method 100 can be scaled up to treat large volumes of water, such as what may be found at a water treatment facility. For example, a plurality of DBD plasma jet devices can be used in parallel to treat large volumes of water.

After treating water containing an organic compound, such as, for example, a cyanotoxin or cyanotoxin byproduct like microcystin, according to the method 100, the water is substantially free of microcystin. The term “substantially free” as referred to herein is intended to mean that the organic compound or toxin (e.g., microcystin) is absent to the extent that undesirable and/or detrimental effects are negligible or nonexistent. By way of example, in certain aspects, water that is “substantially free” of microcystin has a microcystin concentration below microcystin's toxicity level, such as a concentration of less than or equal to about 25 μg/L, less than or equal to about 20 μg/L, less than or equal to about 15 μg/L, less than or equal to about 10 μg/L, less than or equal to about 5 μg/L, less than or equal to about 1 μg/L, and optionally less than or equal to about 0.5 μg/L.

Embodiments of the present technology are further illustrated through the following non-limiting examples.

### EXAMPLE 1

### Preparation of Samples

Microcystin-LR (MC-LR) is purchased from Cayman Chemical (Ann Arbor, Mich.). A solution of 100 μg of MC-LR suspended in 200 μL ethanol is prepared.

A small amount of MC-LR in ethanol is dissolved in 500 mL of ultra-pure type-1 water, obtained from a MILLI-Q® integral water purification system commercialized by Millipore Corporation (Billerica, Mass.). The initial MC-LR concentration is 26.658 ng/mL, determined by an ELISA MC-LR test kit and testing samples diluted 10 fold. This ELISA test is an accepted method of detecting microcystin in water at water treatment plants. In the ELISA test, microcystin in solution binds with a known concentration of antigens coupled to wells of a microtiter plate. The microcystin competes for binding with a microcystin-analogue protein bound to the walls of the wells. After this process step, the sample is washed. The wall bound antigens are then functionalized and detected optically. In this manner, the concentration of the microcystin is detected indirectly. Here, approximately 20 mL of sample is distributed individually into amber glass vials for testing. Amber glass vials are used to preserve the MC-LR from light driven decomposition.

### Experimental Set-Up

Microcystin samples are treated with an underwater DBD plasma jet, described above with reference to FIGS. 1A and 1B. Briefly, the device includes a rod electrode enclosed in a dielectric or ceramic tube/housing. A ground electrode used with the device is a coil attached on the external surface of the dielectric tube, located near a second end of the device. Gas, air in this case, is injected into the tube through a first opening to form bubbles near a second opening of the submerged tube. Application of high voltage to the central rod electrode produces streamer plasma in the bubbles. The streamer plasma in the bubbles produces a host of species, such as electrons, ions, ozone, excited nitrogen, and hydrogen peroxide. An external mechanical pump is used to supply air at a flow of approximately 1.4 L/min. The device is powered using a high voltage nanosecond pulsed power modulator capable of providing positive voltage pulses of up to 15 kV at a repetition rate as high as 10 kHz. A peak voltage of about 13.3 kV at a repetition rate of 5.13 kHz is employed. The DBD plasma jet device is operated in a 40 mL amber glass vial containing the microcystin sample.

Samples are treated for various time intervals, ranging from 30 seconds to 30 minutes. Although boiling will not destroy microcystin, the vials are placed in a water bath to stabilize process temperature and to prevent evaporation.

Concentrations of remaining MC-LR are then measured using an ELISA kit. As previously mentioned, the ELISA kit works via competitive binding with a target molecule, and quantification of sample concentration via spectrophotometry is compared to measurements of standards with known concentrations. Therefore, if the concentration of the target compound in the samples exceeds that of the most concentrated standard, the response will only be qualitative. Similarly, near the limit of response elicited by a negative standard, which contains no microcystin but is used to account for fluctuations in spectrophotometry measurements, the response can only be qualitative.

OH radicals (OH^{⋅}) form from water contacting the plasma, which drives decomposition of organic components in water. OH^{⋅} is highly reactive and its recombination leads to the production of hydrogen peroxide (H₂O₂). Hydrogen peroxide, in the presence of plasma-produced UV light or plasma-produced ozone, in turn produces OH^{⋅} in solution again. Unlike OH^{⋅}, peroxide is a long-lived species and is postulated to play an important role in the decomposition of organics in water. Hydrogen peroxide production is therefore tracked as a function of time. More particularly, hydrogen peroxide concentration is measured using a hydrogen peroxide test kit, model HYP-1, commercialized by Hach (Loveland, Colo.). The concentration of hydrogen peroxide is detected by dissolving ammonium molybdate (a catalyst) and a starch-iodide reagent in the test solution and titrating it against sodium thiosulfate according to the manufacturer's instructions. On contact with hydrogen peroxide in solution, iodide from the starch-iodide reagent reduces hydrogen peroxide to produce iodine and water. The iodine is then trapped within a starch molecule to form a complex that appears dark blue when dissolved in water. Sodium thiosulfate can be used to titrate iodine; thus the amount of sodium thiosulfate that is used to extract all the iodine trapped can be used to determine the amount of hydrogen peroxide in the solution.

Fragments of MC-LR, post-treatment, are analyzed using high pressure liquid chromatography/quadrupole time-of-flight (HPLC/Q-TOF) Mass Spectrometer manufactured by Agilent Technologies (Santa Clara, Calif.) and provided by the Department of Chemistry at the University of Michigan (Ann Arbor, Mich.). An Agilent Zorbax Eclipse Plus C-18 column (2.1 mm×50 mm×1.8 micron) is used, where solvent A is water with 0.1% formic acid and solvent B is 95% acetonitrile with 5% water with 0.1% formic acid. The spectrometer is run in the 2 GHz extended dynamic range mode with low mass range, which is M/Z from 50 to 1700. During each run, 20 μL of sample is injected with a flow rate of 0.4 mL/min; where the sample stays at 95% of solvent A and 5% of solvent B for 2 minutes and slowly increases in gradient to 100% acetonitrile from 2 to 15 minutes.

### Results and Discussion

Quantification of MC-LR Reduction Using ELISA.

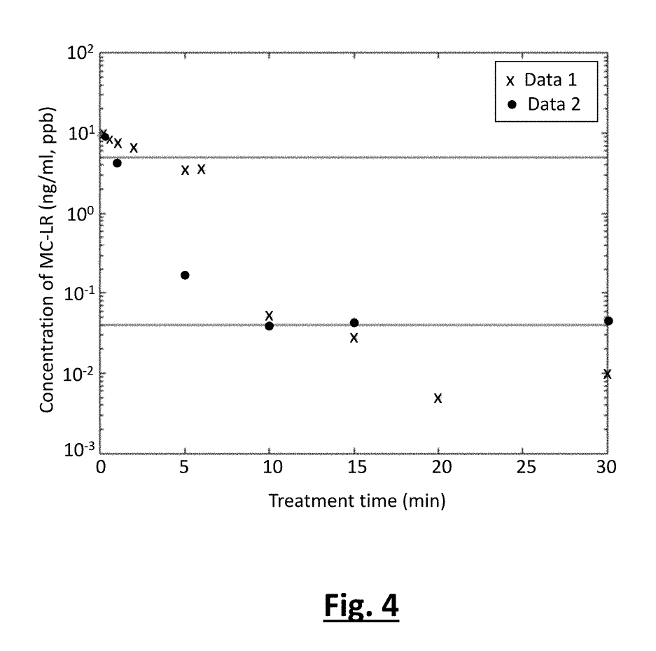

The concentration of MC-LR remaining in solution as a function of plasma treatment time for two experiments is shown in FIG. 4. Horizontal lines are placed on the plot to indicate the sensitivity boundaries of the method. Only qualitative trends can be inferred outside these boundary lines. Data set 2 is obtained with a peak voltage of 13.3 kV with a repetition rate of 5.13 kHz, where the parameters in data set 1 are at approximate levels but are not obtained quantitatively.

For samples with remaining concentrations of MC-LR within the acceptable range, a percentage removal of MC-LR is calculated. In both data sets, the removal percentage is greater than 99% after 10 minutes of testing. The variability shown in the data after 5 minutes is possibly due to the lower peak voltage and repetition rate for data set 1, resulting in lower energy deposition, thus lower percentage removal. Such high percentage removal rates are attributed to MC-LR active groups' susceptibility to ozone, UV rays and hydroxyl radicals produced in the plasma discharge.

While not limiting the present disclosure to any particular theory, the actual degradation mechanism is believed to be multi-stage, at least under conditions that prevail when the plasma is active and where UV, ozone, and OH are all present. It has been shown that under such conditions generated conventionally (non-plasma), UV light gives rise to geometrical isomerization of the toxin and in particular disrupting the biologically active portion of the molecule. OH radicals then further attack and destroy the molecular structure.

Production of Hydrogen Peroxide.

Photolysis and direct electron impact of a hydrogen peroxide molecule (as previously stated) leads to the production of more OH^{⋅}. OH^{⋅} attacks organic molecules via processes such as hydrogen abstraction, which gives rise to the formation of organic peroxides. The presence of organic peroxides is therefore an indicator of advanced oxidation of the microcystin. Accordingly, the production rate of hydrogen peroxide during discharge operation is assessed. To access hydrogen peroxide production, ultra-pure type-1 water is treated using the same discharge cell. Using a Hach hydrogen peroxide test kit, samples diluted to 10 to 30 folds are tested. Samples are diluted because the test kit has a test range of 1-10 mg/L, and the sample concentrations exceed the possible maximum concentration detectable. Multiple dilution ratios are used to calculate extrapolated concentrations to minimize error.

For samples treated for 1 minute, with 2:1 and 5:1 dilutions, concentrations of hydrogen peroxide are averaged to be 190.5 mg/L with a standard deviation of 10.6 mg/L. For samples treated for 5 minutes, with one 14:1 and two 29:1 dilutions, concentrations of hydrogen peroxide are averaged to be 566.7 mg/L with a standard deviation of 106.9 mg/L.

The sharp increase observed in concentration of hydrogen peroxide correlates directly with the production of OH radicals, which are highly reactive and can attack various active groups in the MC-LR structure. Presence of the peroxide is a clear indicator of the presence of a necessary precursor to a number of advanced oxidation processes. A model for the degradation pathways is somewhat complicated in that a number of advanced oxidation processes are likely active during treatment. Additionally, the presence of decomposition intermediates further complicates analysis.

High-Pressure Liquid Chromatography-Mass Spectrometry.

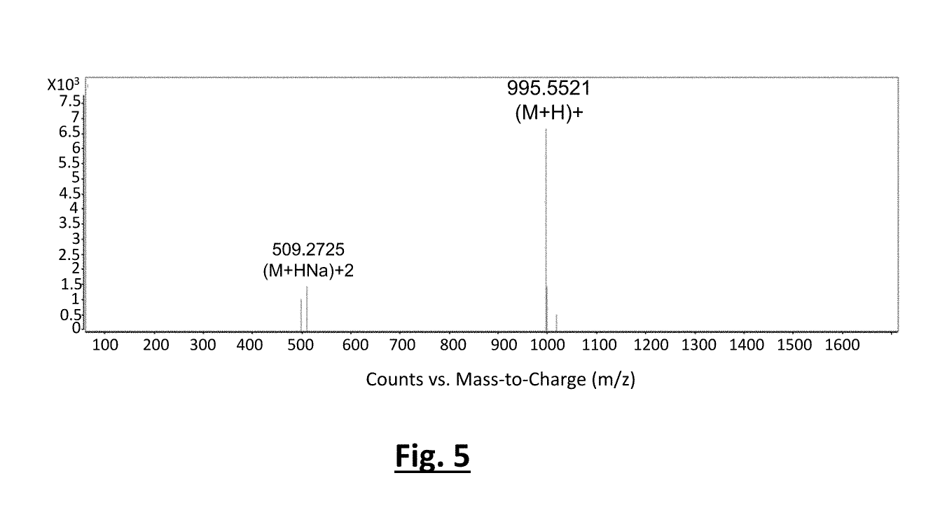

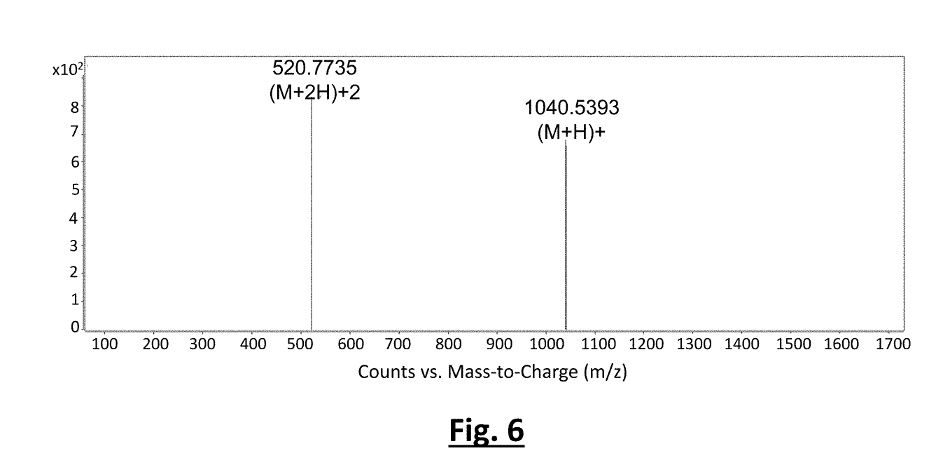

High-pressure liquid chromatography-mass spectrometry is used to gain some insight into decomposition pathways. A sample of ultra-pure type-1 water is used to establish a baseline of species existing in the system and sample solvent. Untreated sample is found to contain MC-LR (M/Z 995.2), as shown in FIG. 5, whereas its level is undetected in any of the treated samples. One sample treated for 30 seconds is shown in FIG. 6 at similar acquisition time for comparison, where no MC-LR is detected but some fragments and complexes are observed in low levels. Fragments of M/Z in the proximity of 457 and 485 are detected in most of the treated samples in low levels.

### Conclusion

An underwater DBD plasma jet is used to successfully decompose MC-LR in a water solution. Plasma treatment times for a 20 ml vial of solution showed that as much as 99% of the toxin could be removed in just under 5 minutes using a single, low power plasma jet. The data suggest that the decomposition mechanism is driven by hydroxyl radical attack on active groups of the MC-LR structure as inferred by the presence of the hydrogen peroxide in solution. This method can be scaled up to pretreat large volumes of water believed to be contaminated with microcystin. Here, however, ultra-pure type-1 water is used to remove interference effects associated with organic matter in solution. This approach allows for an accurate and unambiguous assessment of the plasma effect on the MC-LR toxin. However, at drinking water plants, input water to be treated may have a heavy organic load as well as increased conductivity. One method for scaling up the method to treat large volumes or flowrates of water is to operate a number of DBD plasma jet devices concurrently. For example, a plurality of DBD plasma jet devices may be placed in a parallel configuration for high volume water treatment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for treating water, the method comprising:
feeding gas through a dielectric barrier discharge (DBD) jet device having an electrode and a ground electrode disposed in water comprising at least one organic toxin derived from a biological organism to generate a cavity in the water; and
powering the electrode such that a plasma jet is generated in the cavity,
wherein the plasma jet interacts with the water to generate oxidizing agents that oxidize and decompose the at least one organic toxin in the water.

2. The method according to claim 1, wherein the feeding gas through the DBD jet device comprises injecting air into the DBD jet device with an air compressor.

3. The method according to claim 1, wherein the powering the electrode comprises powering the electrode with a variable frequency alternating current (AC) source.

4. The method according to claim 3, wherein the variable frequency AC source provides positive voltage pulses of from greater than or equal to about 1 kV to less than or equal to about 30 kV at a repetition rate of from greater than or equal to about 1 kHz to less than or equal to about 20 kHz.

5. The method according to claim 1, wherein the oxidizing agents comprise hydroxyl radicals, hydrogen peroxide, and ozone.

6. The method according to claim 1, wherein the at least one organic toxin comprises microcystin-LR.

7. The method according to claim 1, further comprising:
filtering the water to remove cells and naturally occurring organic molecules.

8. The method according to claim 1, wherein the DBD jet device comprises:
a housing that defines a hollow interior core that extends from a first opening at a first end of the housing to a second opening at a second end of the housing;
a port having a third opening, the port being disposed at a first region of the housing near the first end of the housing, wherein the third opening is in fluid communication with the hollow interior core by way of a bore;
an electrode disposed through the third opening and within the hollow interior core of the housing and that extends through the hollow interior core to a second region near the second end of the housing; and
a ground electrode disposed on the housing at the second region.

9. The method according to claim 8, wherein the housing is composed of a ceramic material.

10. The method according to claim 8, wherein the ground electrode is a wire coil wrapped about the housing at the second region.

11. The method according to claim 10, wherein the ground electrode comprises a coating of insulation.

12. The method according to claim 8, wherein the feeding gas through the DBD jet device comprises feeding gas through the first opening of the housing.

13. The method according to claim 1, wherein the method reduces an amount of the at least one organic toxin in the water by greater than or equal to about 95% to less than or equal to about 99% in greater than or equal to about 1 minute to less than or equal to about 10 minutes.

14. The method according to claim 1, wherein the feeding gas through the DBD jet device further comprises feeding gas through a plurality of DBD jet devices, each DBD jet device having the electrode and the ground electrode disposed in the water to generate a plurality of cavities in the water; and
powering the electrode in each DBD jet device such that a plurality of plasma jets are generated in the plurality of cavities.

15. A method for treating water, the method comprising:
feeding air through a dielectric barrier discharge (DBD) jet device having an electrode and a ground electrode disposed in water comprising a cyanotoxin to generate a cavity in the water; and
powering the electrode such that a plasma jet is generated in the cavity, wherein the plasma jet interacts with the water to generate an oxidizing agent selected from the group consisting of hydroxyl radicals, hydrogen peroxide, ozone, and combinations thereof that oxidizes and decomposes the cyantoxin in the water.

16. The method according to claim 15, wherein the electrode is composed of copper and the ground electrode is a coil of tantalum wire.

17. The method according to claim 16, wherein the tantalum wire includes a polyimide coating.

18. A method for treating water, the method comprising:
feeding gas through a dielectric barrier discharge (DBD) jet device having an electrode and a ground electrode disposed in water comprising at least one organic toxin derived from a biological organism to generate a cavity in the water, the DBD jet device comprising;
a housing that defines a hollow interior core that extends from a first opening at a first end of the housing to a second opening at a second end of the housing,
a port having a third opening, the port being disposed at a first region of the housing near the first end of the housing, wherein the third opening is in fluid communication with the hollow interior core by way of a bore,
the electrode disposed through the third opening and within the hollow interior core of the housing and that extends through the hollow interior core to a second region near the second end of the housing, and
the ground electrode disposed on the housing at the second region;
feeding gas through the first opening of the DBD jet device to generate a cavity in the water below the second opening; and
powering the electrode such that a plasma jet is generated in the cavity,
wherein the plasma jet interacts with the water to generate oxidizing agents that oxidize and decompose the at least one organic toxin in the water.

19. The method according to claim 18, wherein the oxidizing agents are selected from the group consisting of hydroxyl radicals, hydrogen peroxide, ozone, and combinations thereof.

20. The method according to claim 18, wherein the at least one organic toxin comprises microcystin-LR, and the microcystin-LR concentration is reduced in the water by from greater than or equal to about 80% to less than or equal to about 99% in from greater than or equal to about 1 minute to less than or equal to about 24 hours.
